(19) United States
(12) Patent Application Publication
(10) Pub. No.: US 2024/0042720 A1
(43) Pub. Date: Feb. 8, 2024

(54) CONTROL DEVICE, CONTROL METHOD, AND RECORDING MEDIUM

(71) Applicant: OMRON Corporation, KYOTO (JP)

(72) Inventor: Takashi FUJII, Kyoto-shi, KYOTO (JP)

(73) Assignee: OMRON Corporation, KYOTO (JP)

(21) Appl. No.: 18/276,880

(22) PCT Filed: Dec. 16, 2021
(86) PCT No.: PCT/JP2021/046522

§ 371 Date: Aug. 10, 2023

(30) Foreign Application Priority Data
Mar. 4, 2021 (JP) 2021-034801

(51) Int. Cl. B30B 15/14

(52) U.S. Cl. CPC B30B 15/148

(57) ABSTRACT

Provided are a control device, a control method, and a control program, which are able to reduce cycle time as well as to ensure the finishing accuracy of a product in a servo press machine. When a load detection result from a load detector (15) is used to determine that the load acting on a material is in a converged state during a stopping operation for stopping a slider (11) at a bottom dead center position, a controller (5) carries out a raising operation for raising the slider (11) from the bottom dead center position.

### TECHNICAL FIELD

The present disclosure relates to a control device, a control method, and a control program for controlling a servo press machine.

### RELATED ART

In the field of press systems, servo press machines that press a workpiece (material) by using a press tool, which serves as a mold, driven by a servo motor via a slider have become common in recent years.

### CITATION LIST

### Patent Literature

[Patent Literature 1] Japanese Patent Laid-Open No. 2011-098350

### SUMMARY OF INVENTION

### Technical Problem

In a servo press machine, the slider is moved in the vertical direction, and the load on the material can be maximized at a bottom dead center position, which is the lowest point position. In the servo press machine, the deformation of the workpiece is completed during a stop time of the slider at the bottom dead center position (bottom dead center stop time). Therefore, it is possible to improve the finishing accuracy of a product by lengthening the bottom dead center stop time.

On the other hand, an increase in the bottom dead center stop time also causes an increase in the cycle time of machining and results in a decrease in production efficiency. Therefore, the servo press machine is required to ensure the finishing accuracy of the product as well as shorten the cycle time.

In view of the above-described problem, the present disclosure provides a control device, a control method, and a control program that are able to ensure the finishing accuracy of a product in a servo press machine as well as shorten the cycle time.

### Solution to Problem

The present disclosure employs the following configurations to solve the above-described problem.

A control device according to one aspect of the present disclosure is a control device for controlling a servo press machine that performs press working on a material by moving a slider in a vertical direction, and includes a servo motor driving the slider, a position detector detecting a position of the slider, and a load detector detecting a load acting on the material. The control device includes: a controller controlling the servo motor by using a position detection result of the position detector and a load detection result of the load detector. The controller performs: a lowering operation of lowering the slider toward a bottom dead center position which is a lowest point position of the slider, a stopping operation of stopping the slider at the bottom dead center position, and a raising operation of raising the slider from the bottom dead center position, as operations of a series of steps in the press working. Also, the controller determines whether or not the load acting on the material is in a converged state based on the load detection result during the stopping operation, and the controller performs the raising operation in response to determining that the load acting on the material is in the converged state.

Further, a control method according to one aspect of the present disclosure is a control method for controlling a servo press machine that performs press working on a material by moving a slider in a vertical direction, and includes a servo motor driving the slider, a position detector detecting a position of the slider, and a load detector detecting a load acting on the material. The control method includes: a lowering operation step of lowering the slider toward a bottom dead center position which is a lowest point position of the slider; a stopping operation step of stopping the slider at the bottom dead center position; and a raising operation step of raising the slider from the bottom dead center position. The control method includes repeatedly executing a sub-step of determining whether or not the load acting on the material is in a converged state based on a load detection result during the stopping operation step, and the control method proceeds to the raising operation step in response to determining that the load acting on the material is in the converged state.

Further, a control program according to one aspect of the present disclosure is a control program for causing a computer to function as the control device, and the control program causes the computer to function as the controller.

According to the above configurations, it is possible to ensure the finishing accuracy of the product in the servo press machine as well as shorten the cycle time.

### Effects of Invention

According to the present disclosure, it is possible to provide a control device, a control method, and a control program that are able to ensure the finishing accuracy of the product in the servo press machine as well as shorten the cycle time.

### BRIEF DESCRIPTION OF DRAWINGS

FIG. 1 is a block diagram showing a configuration example of the control device and the servo press machine according to the first embodiment of the present disclosure.

FIG. 2 is a functional configuration diagram showing the control system of the servo press machine by the control device.

FIG. 3 is a diagram illustrating a basic operation of the servo press machine.

FIG. 4 is a diagram illustrating a specific configuration example of the predictor shown in FIG. 1.

FIG. 5 is a graph showing a specific example of changes of the load detection result in the servo press machine.

FIG. 6 is a diagram illustrating an operation example of the predictor included in the control device.

FIG. 7 is a diagram illustrating an operation example of the controller included in the control device.

FIG. 8 is a diagram showing a specific mathematical formula used for convergence determination in the controller.

FIG. 9 is a flowchart illustrating an operation example of the control device.

FIG. 10 is a flowchart illustrating another operation example of the control device.

FIG. 11 is an explanatory diagram illustrating a specific example of effects of the control device.

FIG. 12 is a block diagram showing a configuration example of the control device and the servo press machine according to the second embodiment of the present disclosure.

### DESCRIPTION OF EMBODIMENTS

### First Embodiment

### 1. Application Example

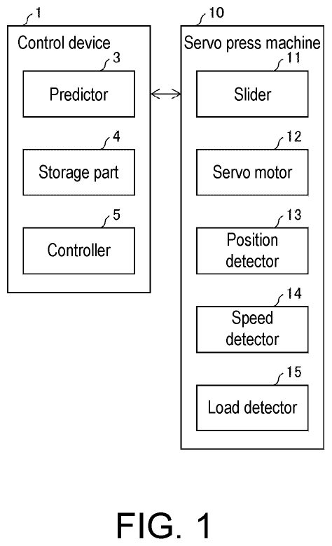

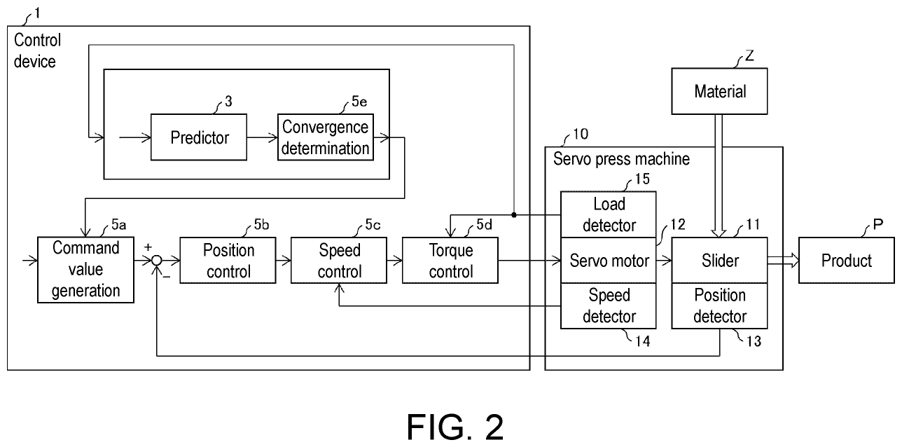

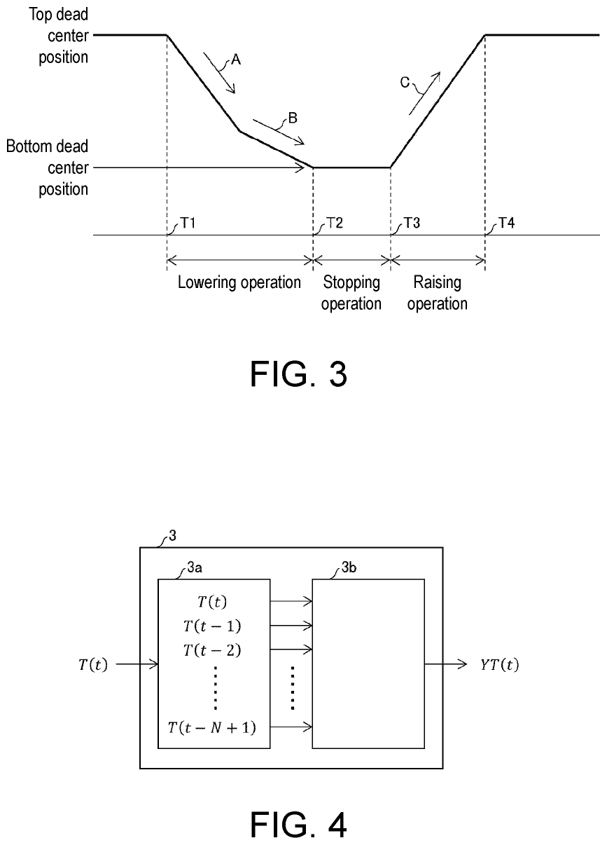

First, an example of a scene to which the present disclosure is applied will be described with reference to FIG. 1 to FIG. 3. FIG. 1 is a block diagram showing a configuration example of a control device and a servo press machine according to the first embodiment of the present disclosure. FIG. 2 is a functional configuration diagram showing a control system of the servo press machine by the control device. FIG. 3 is a diagram illustrating a basic operation of the servo press machine.

In FIG. 1 and FIG. 2, the control device 1 is, for example, a device used at a manufacturing site to control the servo press machine 10. The control device 1 is implemented by, for example, a PLC (Programmable Logic Controller) or a servo driver.

The control device 1 is connected to one or more servo press machines 10. Thus, the control device 1 and the servo press machine 10 constitute a press system that presses a material Z to produce a product P.

The servo press machine 10 is a press machine that uses a servo motor 12, which drives a slider 11, as the power source. Specifically, in the servo press machine 10, an actuator (not shown) converts the rotary motion of the servo motor 12 into linear motion. Then, the servo press machine 10 presses the material Z in contact with a press tool (not shown) attached to the slider 11 by moving the slider 11 in a predetermined vertical direction.

Further, in the servo press machine 10, a lowering operation, a stopping operation, and a raising operation of the slider 11 are performed as a series of step operations in press working. Specifically, in the lowering operation, as shown from time point T1 to time point T2 in FIG. 3, for example, the slider 11 is lowered from the top dead center position, which is the highest point position in the vertical direction, toward the bottom dead center position, which is the lowest point position in the vertical direction.

In the lowering operation of the slider 11, the lowering speed thereof is divided into two steps as indicated by the arrow A and the arrow B in FIG. 3. In other words, when the slider 11 approaches the bottom dead center position, the lowering speed is decelerated. Thus, it is possible to prevent the slider 11 from not being able to stop accurately at the bottom dead center position due to the influence of inertia or the like, and suppress an excessive load on the material Z (overshooting) to greatly suppress the deterioration of the finishing accuracy of the product P.

In addition, in the stopping operation, the slider 11 stops at the bottom dead center position, as shown from time point T2 to time point T3 in FIG. 3. Moreover, in the servo press machine 10, it is possible to improve the finishing accuracy of the product P by appropriately setting the bottom dead center stop time between time point T2 and time point T3 according to the material and thickness of the material Z. The maximum value of the bottom dead center stop time may be determined, for example, based on a trial operation performed by the worker.

Further, in the raising operation, as shown from time point T3 to time point T4 in FIG. 3, for example, the slider 11 rises from the bottom dead center position toward the top dead center position at a constant rising speed (indicated by the arrow C in FIG. 3).

As shown in FIG. 1 and FIG. 2, the control device 1 has a function of collecting data related to the operation of the servo press machine 10 and performing machine learning. The control device 1 acquires information such as the position detection result of the slider 11 from a position detector 13, the speed detection result of the servo motor 12 from a speed detector 14, and the load detection result of the load acting on the material Z from a load detector 15 from the servo press machine 10, for example.

A controller 5 uses the load detection result from the load detector 15 to determine whether or not the load acting on the material Z is in a converged state during the stopping operation of the slider 11. Then, when the controller 5 determines that the load acting on the material Z is in a converged state, the controller 5 causes the slider 11 to perform the raising operation from the stopping operation.

Thus, according to the present embodiment, the control device 1 is able to appropriately change the bottom dead center stop time in the stopping operation, and dynamically change the bottom dead center stop time of the slider 11 according to the load acting on the material Z for the servo press machine 10. As a result, the control device 1 is able to ensure the finishing accuracy of the product P in the servo press machine 10 as well as shorten the cycle time.

### 2. Configuration Example

### First Embodiment

An embodiment of the present disclosure will be described in detail hereinafter. First, the servo press machine 10 to be controlled by the control device 1 of the present embodiment will be described.

### <Regarding Configuration of Servo Press Machine 10>

As shown in FIG. 1 and FIG. 2, the servo press machine 10 includes the slider 11, the servo motor 12, the position detector 13, the speed detector 14, and the load detector 15.

The slider 11 performs the lowering operation and the stopping operation on the material Z, which is in contact with the press tool, by the driving force corresponding to the rotation operation of the servo motor 12 so as to press the material Z and produce the product P. The servo motor 12 performs the rotation operation according to an instruction from the control device 1.

The position detector 13 is a detector that detects the position of the slider 11, and includes, for example, a position sensor such as an optical encoder. The position detector 13 outputs the detection result of the position sensor to the control device 1 as the position detection result of the slider 11.

The speed detector 14 is a detector that detects the rotation speed of the servo motor 12, and includes, for example, a speed sensor using an optical encoder. The speed detector 14 outputs the detection result of the speed sensor to the control device 1 as the speed detection result of the servo motor 12.

The load detector 15 is a detector that detects the load acting on the material Z when the material Z is pressed by the slider 11. The load detector 15 is a load detector that detects the load acting on the material Z by detecting the current of the servo motor 12, for example. Then, the load detector 15 outputs the detection result to the control device 1 as the load detection result of the load acting on the material Z.

In addition to the above description, the load detector 15 may be a load detector that includes a strain gauge provided on a punch (not shown), which transmits at least part of the load from the slider 11 to the material Z, and detects the load acting on the material Z by detecting the amount of strain with the strain gauge.

Furthermore, the load detector 15 is able to detect the stress generated in the material Z during press working by detecting the load acting on the material Z. That is, since stress cannot be measured directly, in the control device 1 of the present embodiment, the load is measured as a physical property value instead of the stress to be used to control the servo press machine 10.

### <Regarding Configuration of Control Device 1>

As shown in FIG. 1, the control device 1 includes a predictor 3, a storage part 4, and a controller 5.

The predictor 3 inputs time-series data of the load detection result from the load detector 15 at each predetermined sampling period, obtains a load prediction value, which is a prediction value of the load acting on the material Z after a predetermined time, from the input time-series data of the load detection result, and outputs the same to the controller 5.

In addition, the predictor 3 has, for example, a neural network which is constructed as a prediction model (learning model) that associates an explanatory variable and an objective variable by using the time-series data of N load detection results (N is an integer of 1 or more) within the first period as the explanatory variable and using the load prediction value after M results (M is an integer of 1 or more) which is after a predetermined time as the objective variable, among the time-series data for each sampling period of the load detection results of one press working input from the load detector 15. Furthermore, the predictor 3 may continue machine learning based on the constructed learning model, and the learning model may be updated sequentially.

Specifically, the predictor 3 has a learning model that performs machine learning by using a set of the data within the first period (in other words, the time-series data of the N load detection results) and the data after the predetermined time from the end time point of the first period (the data after M load detection results), among the time-series data of the load detection results during the stopping operation, as teacher data so as to be generated as a learning model that uses the data within the first period as input and outputs the data after the predetermined time from the end time point of the first period as the load prediction value.

Here, a more specific configuration example of the predictor 3 will be described with reference to FIG. 4. FIG. 4 is a diagram illustrating a specific configuration example of the predictor shown in FIG. 1.

As shown in FIG. 4, the predictor 3 includes a buffer 3a that sequentially acquires data T(t) of the load detection result from the load detector 15, and a learning model 3b that is connected to the buffer 3a and configured by using a neural network.

As shown in FIG. 4, the buffer 3a holds data T(t−N+1) to T(t) within the first period from the load detector 15. The learning model 3b obtains the load prediction value YT(t) after the predetermined time (M results) from time point t, from data T(t−N+1) to T(t) within the first period input from the buffer 3a, and outputs the same to the controller 5.

In addition to the above description, the predictor 3 may be configured by using the buffer 3a and a recurrent neural network (RNN) as the learning model, for example, in place of the learning model 3b configured by using a neural network.

The storage part 4 stores various data to be used by the controller 5. Further, the storage part 4 may store various software that causes a computer to function as the controller 5 or the predictor 3 when executed by the computer. The storage part 4 also stores data related to the operation of the servo press machine 10, which is acquired from the servo press machine 10 and machine-learned by the controller 5. Furthermore, in the storage part 4, data such as a first threshold value, a second threshold value (described later), and the maximum value of the bottom dead center stop time, which is input via an operation part (not shown) to be used for convergence determination (described later), is stored in advance.

The controller 5 is an arithmetic device having a function of centrally controlling each part of the control device 1. For example, one or more processors (for example, CPU) may execute programs stored in one or more memories (for example, RAM, ROM, etc.) for the controller 5 to control each part of the control device 1.

In addition, as shown in FIG. 2, the controller 5 uses the load prediction value from the predictor 3 to dynamically change the bottom dead center stop time. In other words, the controller 5 includes a command value generation function 5a for generating a command value for the servo press machine 10, a position control function 5b for controlling the position of the slider 11, a speed control function 5c for controlling the rotation speed of the servo motor 12, a torque control function 5d for controlling the torque of the servo motor 12, and a convergence determination function 5e for determining the convergence state of the load acting on the material Z.

Further, when the controller 5 determines that the load acting on the material Z is in the converged state by using the load detection result from the load detector 15, the controller 5 outputs an instruction signal (command value) to the servo press machine 10 to instruct the slider 11, which is in the stopping operation, to perform the raising operation.

In addition, when the controller 5 inputs the load prediction value from the predictor 3, the controller 5 uses the load prediction value to determine whether or not the load acting on the material Z is in the converged state. Furthermore, the controller 5 uses the second threshold value preset in the storage part 4 to determine whether or not the load acting on the material Z is in the converged state, as will be described in detail later.

A case where the load prediction value is not input from the predictor 3, that is, a case where the control device 1 is not provided with the predictor 3, will be described in the second embodiment below.

### 3. Operation Example

### <Determination Operation of Convergence State>

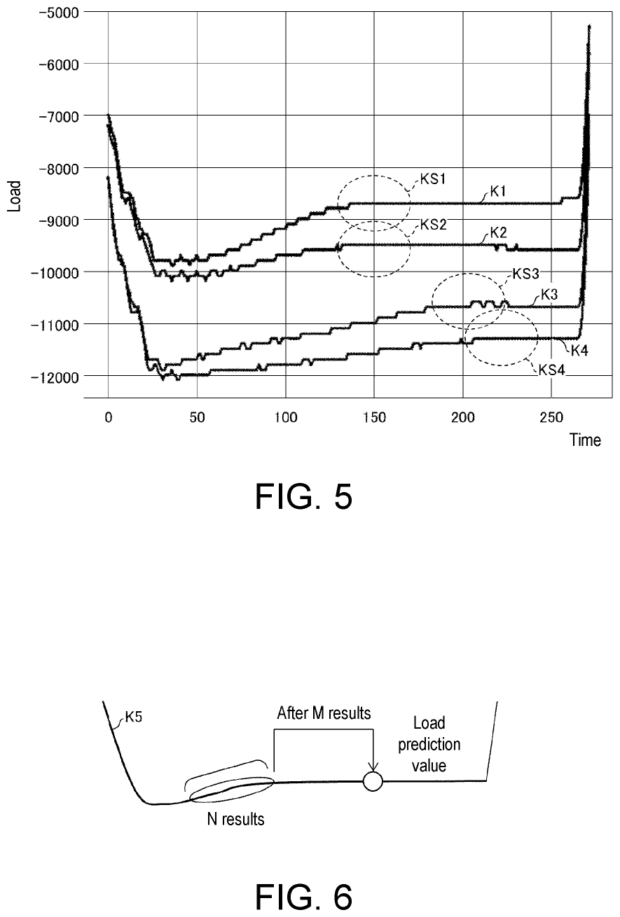

An operation example of the determination operation for the convergence state of the load acting on the material Z in the control device 1 of the present embodiment will be specifically described also with reference to FIG. 5. FIG. 5 is a graph showing a specific example of changes of the load detection result in the servo press machine. The unit of the horizontal axis in FIG. 5 is the time corresponding to the step in press working, and the vertical axis is the load (arbitrary unit).

For example, when the control device 1 causes the servo press machine 10 having the servo motor 12 for four axes to press the same material Z, in the servo motor 12 for the four axes, the loads acting on the material Z vary as respectively indicated by the curves K1, K2, K3, and K4 in FIG. 5. Then, during the stopping operation of the slider 11, in the areas surrounded by the dotted circles KS1, KS2, KS3, and KS4 in FIG. 4, the load on each of the four axes shows a substantially constant value when the deformation of the material Z is completed.

The axis where the load variation is indicated by the curve K4 is the axis that is arranged at the position closest to the mold for press working, and since the load acting on the material Z from this axis converges the latest, the load detection result from the load detector 15 provided on this axis is used for the determination of the convergence state in the control device 1.

In the control device 1 of the present embodiment, when the load detection result from the load detector 15 continues to show a substantially constant value, the controller 5 determines that the load acting on the material Z is in the converged state. Then, the controller 5 causes the servo press machine 10 to raise the slider 11 that is in the stopping operation to prepare for pressing the next material Z.

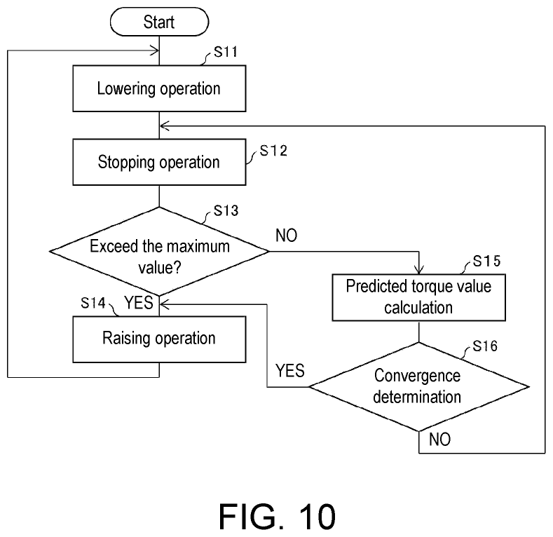

In addition, the controller 5 appropriately sets the maximum value of the bottom dead center stop time according to the material Z. Thus, even if the determination operation for the convergence state cannot be performed appropriately, the controller 5 is able to forcibly terminate the stopping operation of the slider 11 (bottom dead center stop time), as shown in step S13 in FIG. 10 which will be described later, for example.

However, if the maximum value of the bottom dead center stop time is reduced, the springback in the material Z may become large and reduce the finishing accuracy of the product P.

Therefore, in the control device 1 of the present embodiment, the maximum value (time threshold value) of the bottom dead center stop time is determined, for example, based on a trial operation performed by a skilled worker. Thus, even when pressing the same material Z, with the control device 1 of the present embodiment, it is possible to eliminate adverse effects due to variations in thickness of each material Z to ensure the finishing accuracy of the product P and prevent an increase in the cycle time of the product P, thereby preventing a decrease in the productivity of the servo press machine 10.

### <Prediction Operation and Determination Operation>

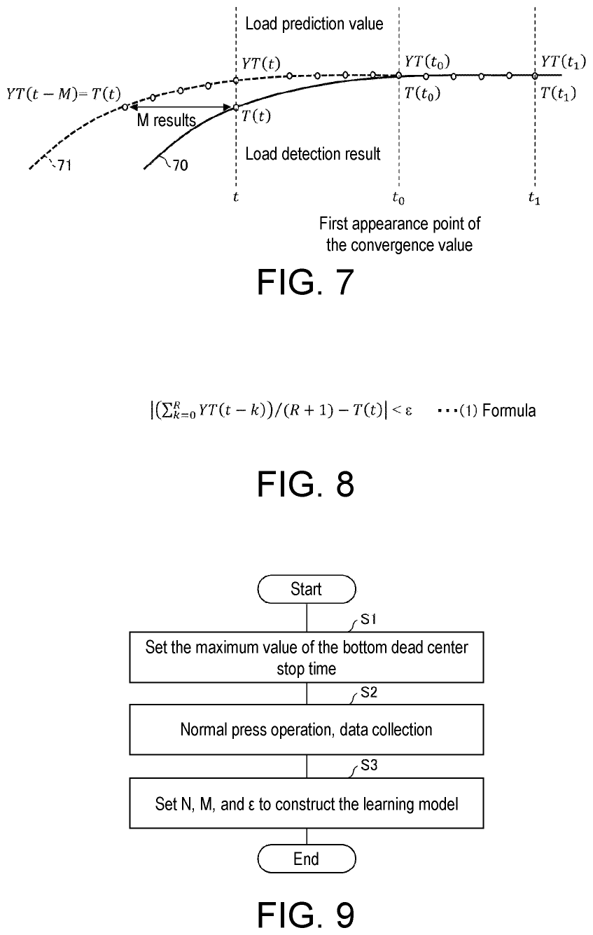

An operation example of the prediction operation performed by the predictor 3 in the control device 1 of the present embodiment and the determination operation performed in the controller 5 using this prediction operation will be specifically described with reference to FIG. 6 to FIG. 8. FIG. 6 is a diagram illustrating an operation example of the predictor included in the control device. FIG. 7 is a diagram illustrating an operation example of the controller included in the control device. FIG. 8 is a diagram showing a specific mathematical formula used for the convergence determination in the controller.

In FIG. 6, the curve K5 shows an example of variation of the load acting on the material Z. Further, in FIG. 6, the time-series data of N load detection results (N is an integer of 1 or more) of press working, for example, data T(t−N+1) to T(t) within the first period shown in FIG. 4, is input to the learning model 3b of the predictor 3 as the explanatory variable. The time-series data of the N load detection results is not limited to the number of times of executing continuously performed press working, and for example, may be determined by using importance analysis based on Random Forest or the like.

The learning model 3b of the predictor 3 calculates the load prediction value YT(t) after M results (M is an integer of 1 or more) of press working, and outputs the calculated load prediction value YT(t) after M results to the controller 5 as the objective variable. In other words, the learning model 3b of the predictor 3 is configured to perform machine learning based on the explanatory variable described above, and output the objective variable.

Next, the controller 5 uses the formula (1) shown in FIG. 8 to perform convergence determination regarding whether or not the load is in the converged state. Here, in FIG. 8, YT(t−k) is the load prediction value for k results before time point t, and T(t) is the load detection result at time point t. In addition, R is the value of the number of samples of the data used for convergence determination (R is an integer of 1 or more), and c is the threshold value for performing convergence determination.

Specifically, as indicated by the curve 70 in FIG. 7, the load detection result from the load detector 15 varies as shown by the value T(t₀) at the first appearance point (the time point at which the load detection result from the load detector 15 becomes a substantially constant value) to of the convergence value for determining the convergence state, the value T(t) at time point t before the first appearance point to, and the value T(t₁) at time point t₁ that is M results after the first appearance point to.

On the other hand, regarding the load prediction value after M results for the load detection result of the curve 70, if the prediction made by the predictor 3 is sufficiently accurate, at the time point before the first appearance point to, YT(t−M)=T(t) is established. As indicated by the curve 71 in FIG. 7, the load prediction value varies as shown by the value YT(t) at time point t, the value YT(t₀) at the first appearance point to, and the value YT(t₁) at time point t₁.

As shown in formula (1), the controller 5 determines that the load acting on the material Z is in the converged state when the difference between the load prediction value newly acquired from the predictor 3 and the average value of the load prediction values within a past predetermined period is equal to or less than the preset second threshold value c. For example, as indicated by the double arrow in FIG. 7, by using the load prediction value, the controller 5 is able to predict the convergence state earlier at time point T₀ which comes before time point T₁, at which the convergence determination is performed using the load detection result, by a step of M results.

The prediction accuracy in the prediction model and the determination accuracy of the convergence state may deteriorate depending on the set value of M, N, or R described above. Therefore, in the control device 1, for example, an evaluation value of the prediction accuracy in the prediction model (for example, root mean square error (RMSE)) may be calculated based on the load detection result and the load prediction value, and the prediction model may be reconstructed according to the calculation result. That is, the control device 1 may be configured to perform machine learning in consideration of the evaluation value described above.

Furthermore, instead of determining the convergence state using the above formula (1), for example, a difference value between successive load prediction values may be calculated, and the convergence state may be determined based on this difference value.

It should be noted that the above M, which is a parameter for the predictor 3 to make prediction, and the above R, which is a parameter used by the controller 5 for convergence determination, may use different values or may use the same value.

### <Operation Example of Control Device 1>

An operation example of the control device 1 of the present embodiment will be specifically described with reference to FIG. 9 and FIG. 10 as well. FIG. 9 is a flowchart illustrating an operation example of the control device. FIG. 10 is a flowchart illustrating another operation example of the control device.

In FIG. 9, first, in step S1, the maximum value of the bottom dead center stop time is set in the control device 1 according to an operation of the user. Specifically, before pressing the material Z, for example, a trial operation is performed by a skilled worker, so as to store the maximum bottom dead center stop time, among variations of the bottom dead center stop time that changes in each press working resulting from the thickness of the material Z, elastic deformation and thermal expansion occurring in the slider 11 in the servo press machine 10, or the like, in advance in the storage part 4 as the maximum value (time threshold value) of the bottom dead center stop time.

Next, in step S2, the control device 1 causes the servo press machine 10 to perform a normal press operation (press working) to collect time-series data of the load detection result.

Next, in step S3, the control device 1 constructs a learning model in the predictor 3 according to the values of N, M, and c set by the user.

After constructing the learning model in the predictor 3, the control device 1 performs press working using the constructed learning model. The processing of the press working to which the control device 1 is applied will be described hereinafter. In step S11 in FIG. 10, the servo press machine 10 is caused to perform the lowering operation of the slider 11.

Next, in step S12, the control device 1 causes the servo press machine 10 to perform the stopping operation of the slider 11.

Next, in step S13, the control device 1 determines whether or not the bottom dead center stop time in the stopping operation has exceeded the maximum value stored in the storage part 4. If the control device 1 determines that the bottom dead center stop time in the stopping operation has exceeded the maximum value (YES in S13), the control device 1 determines that it is not necessary to continue the stopping operation, and proceeds to step S14. That is, the control device 1 forcibly terminates the stopping operation and causes the raising operation to be performed.

On the other hand, if the control device 1 determines that the bottom dead center stop time in the stopping operation does not exceed the maximum value (NO in S13), the predictor 3 calculates the load prediction value based on the prediction model (step S15).

Subsequently, in step S16, the controller 5 determines whether or not the load detection result from the load detector 15 is in the converged state. If the controller 5 determines that the load detection result is not in the converged state (NO in S16), the control device 1 determines that it is necessary to continue the stopping operation, and proceeds to step S12.

On the other hand, if the controller 5 determines that the load detection result is in the converged state (YES in S16), the control device 1 determines that it is not necessary to continue the stopping operation, and proceeds to step S14.

Then, in step S14, the control device 1 causes the servo press machine 10 to terminate the stopping operation of the slider 11 and perform the raising operation.

As described above, in the control device 1 of the present embodiment, the load detection result from the load detector 15 is used to determine whether or not the load acting on the material Z is in the converged state during the stopping operation of the slider 11. Then, when the control device 1 determines that the load acting on the material Z is in the converged state, the control device 1 terminates the stopping operation of the slider 11 to perform the raising operation of the slider 11 immediately. Thus, with the control device 1 of the present embodiment, it is possible to appropriately change the bottom dead center stop time in the stopping operation, and to dynamically change the bottom dead center stop time of the slider 11 according to the load acting on the material Z for the servo press machine 10.

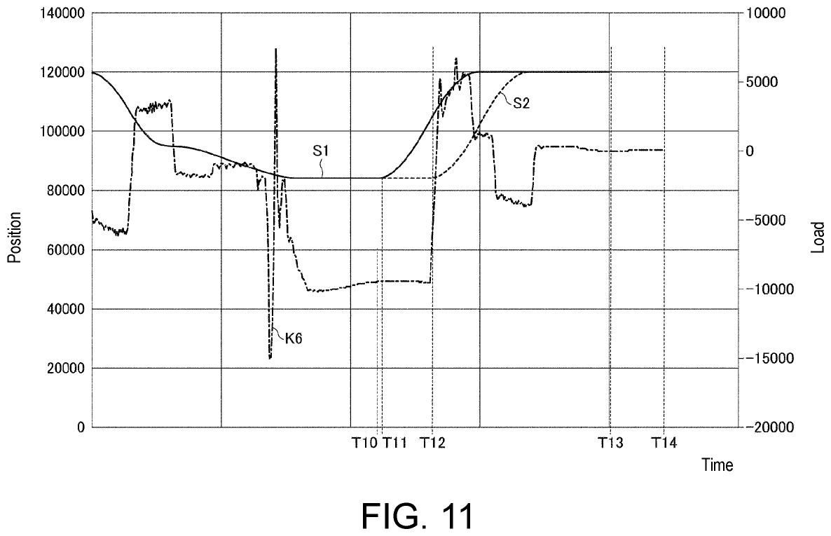

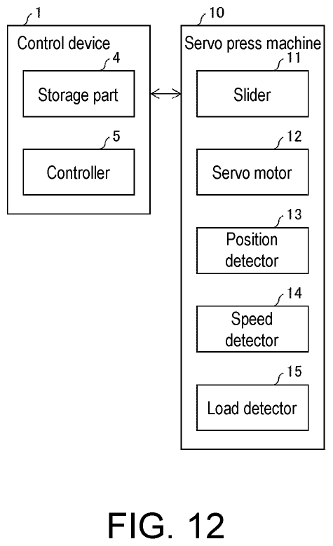

Here, the effects of the control device 1 of the present embodiment will be specifically described with reference to FIG. 11. FIG. 11 is an explanatory diagram illustrating a specific example of the effects of the control device. The unit of the horizontal axis in FIG. 11 is the time corresponding to the step in press working, and the vertical axis is the load (arbitrary unit) and the position of the slider 11 (arbitrary unit).

In FIG. 11, when the servo press machine 10 performs press working, the load detection result from the load detector 15 varies as illustrated by the one-dot chain line K6. Here, when the controller 5 determines that the load acting on the material Z is in the converged state at time point T10, the control device 1 causes the servo press machine 10 to terminate the stopping operation of the slider 11 and start the raising operation at time point T11.

As a result, in the servo press machine 10, the slider 11 rises from the bottom dead center position toward the top dead center position at time point T11, as indicated by the curve S1. Then, in the servo press machine 10, the slider 11 becomes able to press the next material Z at time point T13.

In contrast, in a comparative example that does not dynamically change the bottom dead center stop time, for example, when the bottom dead center stop time ends at time point T12, the servo press machine of the comparative example raises the slider from the bottom dead center position toward the top dead center position at time point T12, as indicated by the curve S2. Therefore, in the comparative example, the slider becomes able to press the next material Z at time point T14.

That is, as shown in FIG. 11, with the control device 1 of the present embodiment, it is possible to shorten the cycle time by the time difference from time point T14 to time point T13 while maintaining the finishing accuracy of the product P, compared to the comparative example.

Specifically, since the control device 1 of the present embodiment determines that the load acting on the material Z is in the converged state, plastic deformation of the pressed material Z is completed. In other words, in the control device 1 of the present embodiment, the above determination is performed to detect that the material Z is in a state where springback is unlikely to occur, so the finishing accuracy of the product P can be easily ensured.

Further, even if there is variation in the material Z, for example, there is variation in the thickness in the case where the material Z is a plate-shaped member, the control device 1 of the present embodiment detects that each material Z is in a state where springback is unlikely to occur as described above. Therefore, with the control device 1 of the present embodiment, the finishing accuracy of the product P can be easily ensured even if there is variation in the material Z.

Furthermore, since the control device 1 of the present embodiment uses machine learning performed by the predictor 3, it is possible to quickly determine that the load on the material Z is in the converged state, and it is possible to perform convergence determination at an early stage. As a result, the control device 1 of the present embodiment is able to shorten the cycle time easily.

### Second Embodiment

Another embodiment of the present disclosure will be described hereinafter with reference to FIG. 12. FIG. 12 is a block diagram showing a configuration example of the control device and the servo press machine according to the second embodiment of the present disclosure. For convenience of description, members having the same functions as the members described in the above embodiment are denoted by the same reference numerals, and description thereof will not be repeated.

The main difference between the second embodiment and the first embodiment is that the installation of the predictor 3 is omitted from the control device 1.

In the control device 1 of the second embodiment, the load detection result from the load detector 15 is input to the convergence determination function 5e of the controller 5, in place of the load prediction value YT(t) output by the predictor 3 in the first embodiment.

Then, the controller 5 of the control device 1 of the second embodiment determines that the load acting on the material Z is in the converged state, for example, when the difference between the load detection result newly acquired from the load detector 15 and the average value of the load detection results within the past predetermined period is less than a preset first threshold value. Thus, as in the first embodiment, with the control device 1 of the second embodiment, it is possible to appropriately change the bottom dead center stop time in the stopping operation, and it is possible to dynamically change the bottom dead center stop time of the slider 11 according to the load acting on the material Z for the servo press machine 10.

As a result, as in the first embodiment, with the control device 1 of the second embodiment, it is possible to ensure the finishing accuracy of the product P in the servo press machine 10 as well as shorten the cycle time.

### [Example of Implementation by Software]

The functional blocks (in particular, the controller 5) of the control device 1 may be implemented by a logic circuit (hardware) formed in an integrated circuit (IC chip) or the like, or may be implemented by software.

In the latter case, the controller 5 includes a computer that executes instructions of a program, which is software that implements each function. This computer includes, for example, one or more processors, and a computer-readable recording medium storing the program. Then, in the computer, the processor reads the program from the recording medium and executes the program, thereby achieving the object of the present disclosure.

As the processor, for example, a CPU (Central Processing Unit) can be used. As the recording medium, a “non-transitory tangible medium” such as a ROM (Read Only Memory), a magnetic disk, a card, a semiconductor memory, and a programmable logic circuit can be used. In addition, a RAM (Random Access Memory) for expanding the program may be further provided.

Furthermore, the program may be supplied to the computer via any transmission medium (communication network, broadcast wave, etc.) capable of transmitting the program. One aspect of the present invention can also be implemented in the form of a data signal embedded in a carrier wave in which the program is embodied by electronic transmission.

### SUMMARY

A control device according to one aspect of the present disclosure is a control device for controlling a servo press machine that performs press working on a material by moving a slider in a vertical direction, and includes a servo motor driving the slider, a position detector detecting a position of the slider, and a load detector detecting a load acting on the material. The control device includes: a controller controlling the servo motor by using a position detection result of the position detector and a load detection result of the load detector. The controller performs: a lowering operation of lowering the slider toward a bottom dead center position which is a lowest point position of the slider, a stopping operation of stopping the slider at the bottom dead center position, and a raising operation of raising the slider from the bottom dead center position, as operations of a series of steps in the press working. Also, the controller determines whether or not the load acting on the material is in a converged state based on the load detection result during the stopping operation, and the controller performs the raising operation in response to determining that the load acting on the material is in the converged state.

According to the above configuration, it is possible to ensure the finishing accuracy of the product in the servo press machine as well as shorten the cycle time.

In the control device according to the above aspect, the controller may determine that the load acting on the material is in the converged state in response to a difference between the load detection result newly acquired from the load detector and an average value of the load detection result within a past predetermined period being less than a preset first threshold value.

According to the above configuration, it is possible to reliably improve the determination accuracy as to whether or not the load is in the converged state.

The control device according to the above aspect may further include a predictor that acquires the load detection result from the load detector, obtains a load prediction value which is a prediction value of the load acting on the material after a predetermined time from time-series data of the load detection result acquired, and outputs the load prediction value to the controller. The controller may determine whether or not the load acting on the material is in the converged state by using the load prediction value during the stopping operation.

According to the above configuration, it is possible to quickly determine that the load is in the converged state by utilizing prediction using machine learning, and to perform convergence determination at an early stage.

In the control device according to the above aspect, the controller may determine that the load acting on the material is in the converged state in response to a difference between the load prediction value newly acquired from the predictor and an average value of the load prediction value within a past predetermined period being less than a preset second threshold value.

According to the above configuration, it is possible to reliably improve the determination accuracy as to whether or not the load is in the converged state.

In the control device according to the above aspect, the predictor may include a learning model, which performs machine learning by using a set of data within a first period and data after the predetermined time from an end time point of the first period, among time-series data of the load detection result during the stopping operation, as teacher data so as to be generated as a learning model that uses the data within the first period as input and outputs by using the data after the predetermined time from the end time point of the first period as the load prediction value.

According to the above configuration, since a learning model subjected to machine learning is used in the predictor, it is possible to dynamically change the bottom dead center stop time of the servo press machine more appropriately.

In the control device according to the above aspect, the load detector may be a load detector that detects the load acting on the material by detecting a torque of the servo motor.

According to the above configuration, by using the torque of the servo motor, it is possible to detect the load acting on the material without providing a separate sensor.

In the control device according to the above aspect, the load detector may be a load detector that includes a strain gauge provided on a punch which transmits at least part of a load from the slider to the material, and detects the load acting on the material by detecting an amount of strain with the strain gauge.

According to the above configuration, by using the amount of strain detected by the strain gauge, it is possible to more directly detect the load acting on the material.

Further, a control method according to one aspect of the present disclosure is a control method for controlling a servo press machine that performs press working on a material by moving a slider in a vertical direction, and includes a servo motor driving the slider, a position detector detecting a position of the slider, and a load detector detecting a load acting on the material. The control method includes: a lowering operation step of lowering the slider toward a bottom dead center position which is a lowest point position of the slider; a stopping operation step of stopping the slider at the bottom dead center position; and a raising operation step of raising the slider from the bottom dead center position. The control method includes repeatedly executing a sub-step of determining whether or not the load acting on the material is in a converged state based on a load detection result during the stopping operation step, and the control method proceeds to the raising operation step in response to determining that the load acting on the material is in the converged state.

According to the above configuration, it is possible to ensure the finishing accuracy of the product in the servo press machine as well as shorten the cycle time.

A control program according to one aspect of the present disclosure is a control program for causing a computer to function as the control device, and the control program causes the computer to function as the controller.

According to the above configuration, it is possible to ensure the finishing accuracy of the product in the servo press machine as well as shorten the cycle time.

The present disclosure is not limited to the above-described embodiments, and various modifications are possible within the scope defined by the claims. Embodiments obtained by appropriately combining technical means disclosed in different embodiments are also included in the technical scope of the present disclosure.

### REFERENCE SIGNS LIST

1 control device
3 predictor
5 controller
10 servo press machine
11 slider
12 servo motor
15 load detector

1. A control device for controlling a servo press machine that performs press working on a material by moving a slider in a vertical direction, and comprises a servo motor driving the slider, a position detector detecting a position of the slider, and a load detector detecting a load acting on the material, the control device comprising:
a controller controlling the servo motor by using a position detection result of the position detector and a load detection result of the load detector,
wherein the controller performs:
a lowering operation of lowering the slider toward a bottom dead center position which is a lowest point position of the slider,
a stopping operation of stopping the slider at the bottom dead center position, and
a raising operation of raising the slider from the bottom dead center position, as operations of a series of steps in the press working,
the controller determines whether or not the load acting on the material is in a converged state based on the load detection result during the stopping operation, and
the controller performs the raising operation in response to determining that the load acting on the material is in the converged state.

2. The control device according to claim 1, wherein the controller determines that the load acting on the material is in the converged state in response to a difference between the load detection result newly acquired from the load detector and an average value of the load detection result within a past predetermined period being less than a preset first threshold value.

3. The control device according to claim 1, further comprising a predictor that acquires the load detection result from the load detector, obtains a load prediction value which is a prediction value of the load acting on the material after a predetermined time from time-series data of the load detection result acquired, and outputs the load prediction value to the controller,
wherein the controller determines whether or not the load acting on the material is in the converged state by using the load prediction value during the stopping operation.

4. The control device according to claim 3, wherein the controller determines that the load acting on the material is in the converged state in response to a difference between the load prediction value newly acquired from the predictor and an average value of the load prediction value within a past predetermined period being less than a preset second threshold value.

5. The control device according to claim 3, wherein the predictor comprises a learning model, which performs machine learning by using a set of data within a first period and data after the predetermined time from an end time point of the first period, among time-series data of the load detection result during the stopping operation, as teacher data so as to be generated as a learning model that uses the data within the first period as input and outputs by using the data after the predetermined time from the end time point of the first period as the load prediction value.

6. The control device according to claim 1, wherein the load detector is a load detector that detects the load acting on the material by detecting a torque of the servo motor.

7. The control device according to claim 1, wherein the load detector is a load detector that comprises a strain gauge provided on a punch which transmits at least part of a load from the slider to the material, and detects the load acting on the material by detecting an amount of strain with the strain gauge.

8. A control method for controlling a servo press machine that performs press working on a material by moving a slider in a vertical direction, and comprises a servo motor driving the slider, a position detector detecting a position of the slider, and a load detector detecting a load acting on the material, the control method comprising:
a lowering operation step of lowering the slider toward a bottom dead center position which is a lowest point position of the slider;
a stopping operation step of stopping the slider at the bottom dead center position; and
a raising operation step of raising the slider from the bottom dead center position,
wherein the control method comprises repeatedly executing a sub-step of determining whether or not the load acting on the material is in a converged state based on a load detection result during the stopping operation step, and
the control method proceeds to the raising operation step in response to determining that the load acting on the material is in the converged state.

9. A non-transient computer-readable recording medium, recording a control program for causing a computer to function as the control device according to claim 1, the control program causing the computer to function as the controller.

10. The control device according to claim 4, wherein the predictor comprises a learning model, which performs machine learning by using a set of data within a first period and data after the predetermined time from an end time point of the first period, among time-series data of the load detection result during the stopping operation, as teacher data so as to be generated as a learning model that uses the data within the first period as input and outputs by using the data after the predetermined time from the end time point of the first period as the load prediction value.

11. The control device according to claim 2, wherein the load detector is a load detector that detects the load acting on the material by detecting a torque of the servo motor.

12. The control device according to claim 3, wherein the load detector is a load detector that detects the load acting on the material by detecting a torque of the servo motor.

13. The control device according to claim 4, wherein the load detector is a load detector that detects the load acting on the material by detecting a torque of the servo motor.

14. The control device according to claim 5, wherein the load detector is a load detector that detects the load acting on the material by detecting a torque of the servo motor.

15. The control device according to claim 2, wherein the load detector is a load detector that comprises a strain gauge provided on a punch which transmits at least part of a load from the slider to the material, and detects the load acting on the material by detecting an amount of strain with the strain gauge.

16. The control device according to claim 3, wherein the load detector is a load detector that comprises a strain gauge provided on a punch which transmits at least part of a load from the slider to the material, and detects the load acting on the material by detecting an amount of strain with the strain gauge.

17. The control device according to claim 4, wherein the load detector is a load detector that comprises a strain gauge provided on a punch which transmits at least part of a load from the slider to the material, and detects the load acting on the material by detecting an amount of strain with the strain gauge.

18. The control device according to claim 5, wherein the load detector is a load detector that comprises a strain gauge provided on a punch which transmits at least part of a load from the slider to the material, and detects the load acting on the material by detecting an amount of strain with the strain gauge.
